(19) United States
(12) Patent Application Publication
(10) Pub. No.: US 2025/0110747 A1
(43) Pub. Date: Apr. 3, 2025

(54) PARALLEL PROCESSING CONTROL

(71) Applicant: Arm Limited, Cambridge (GB)

(72) Inventors: Maochang Dang, Shanghai (CN); Andreas Danner Nilsen, Trondheim (NO); Mark Underwood, Cambridge (GB); Brian Gordon Pearson, Trøndelag (NO); Espen Amodt, Shanghai (CN); Xinyu Chen, Trondheim (NO)

(21) Appl. No.: 18/478,345

(22) Filed: Sep. 29, 2023

(51) Int. Cl. G06F 9/38; G06F 9/30

(52) U.S. Cl. CPC G06F 9/3885; G06F 9/30087; G06F 9/3838

(57) ABSTRACT

A method of preparing a command stream for a parallel processor, comprising: analysing the command stream to detect at least a first dependency; generating at least one timeline dependency point responsive to detecting the first dependency; determining a latest action for the first dependency to derive a completion stream timeline point for the first dependency; comparing the completion stream timeline point for the first dependency with a completion stream timeline point for a second dependency to determine a latest stream timeline point; generating at least one command stream synchronization control instruction according to the latest stream timeline point; and providing the command stream and the at least one command stream synchronization control instruction to an execution unit of the parallel processor.

The present technology is directed to the control of parallel processing in electronic systems, such as electronic computing systems, and in particular to the control of synchronization in command stream based parallel processing.

In an approach to addressing some difficulties in the control of synchronization in command stream based parallel processing, the present technology provides, in a first approach, a method of preparing a command stream for a parallel processor, comprising: analysing the command stream to detect at least a first dependency; generating at least one timeline dependency point responsive to detecting the first dependency; determining a latest action for the first dependency to derive a completion stream timeline point for the first dependency; comparing the completion stream timeline point for the first dependency with a completion stream timeline point for a second dependency to determine a latest stream timeline point; generating at least one command stream synchronization control instruction according to the latest stream timeline point; and providing the command stream and the at least one command stream synchronization control instruction to an execution unit of the parallel processor.

The method may thus be used to control synchronization in command stream based parallel processing according to the present technology, and that method may be realised in the form of a non-transitory storage medium storing a computer program operable to cause a computer system to perform the process of the present technology as described hereinabove. As will be clear to one of skill in the art, a hybrid approach may also be taken, in which hardware logic, firmware and/or software may be used in any combination to implement the present technology.

In a further approach, there may be provided an apparatus for preparing a command stream for a parallel processor, comprising: a memory; and a processor having logic circuits comprising: a dependency detector operable to analyse the command stream to detect at least a first dependency; a stream timeline point generator operable to generate at least one timeline dependency point responsive to detecting the first dependency; a timeline dependency point analyser operable to determine a latest action for the first dependency to derive a completion stream timeline point for the first dependency; a comparator operable to compare the completion stream timeline point for the first dependency with a completion stream timeline point for a second dependency to determine a latest stream timeline point; a command stream synchronization control instruction generator operable to generate at least one command stream synchronization control instruction according to the latest stream timeline point; and an output generator operable to provide the command stream and the at least one command stream synchronization control instruction to an execution unit of the parallel processor.

Implementations of the disclosed technology will now be described, by way of example only, with reference to the accompanying drawings, in which:

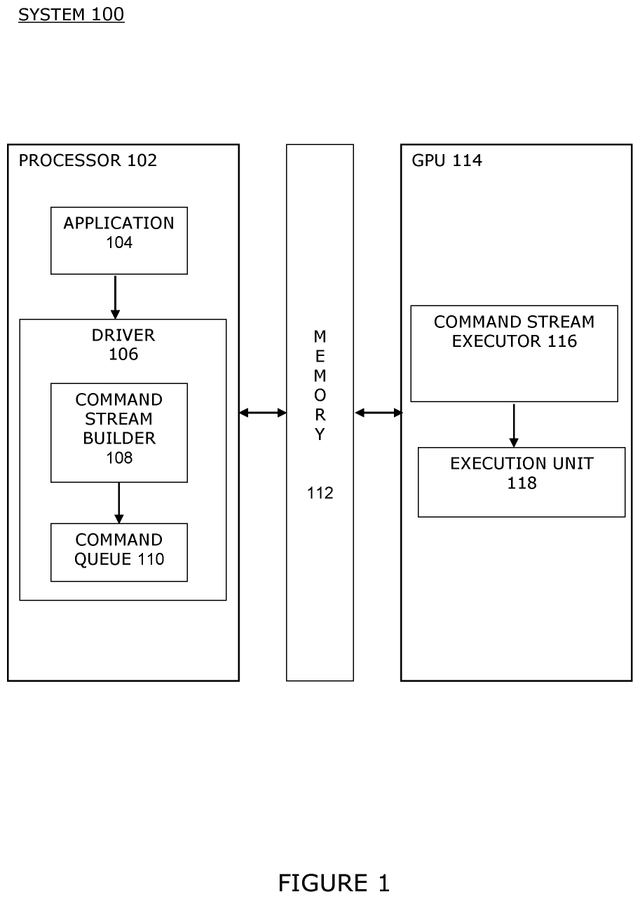

FIG. 1 shows a simplified example of a system in which an implementation of the present technology may operate and comprising hardware, firmware, software or hybrid components;

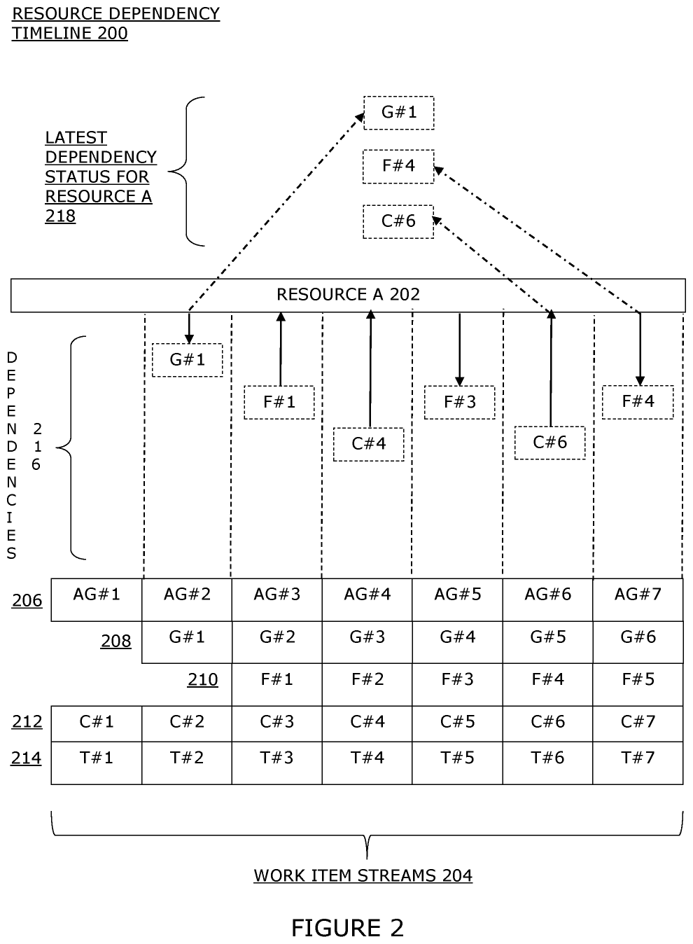

FIG. 2 shows a simple example of the analysis of resource dependencies according to an implementation of the present technology;

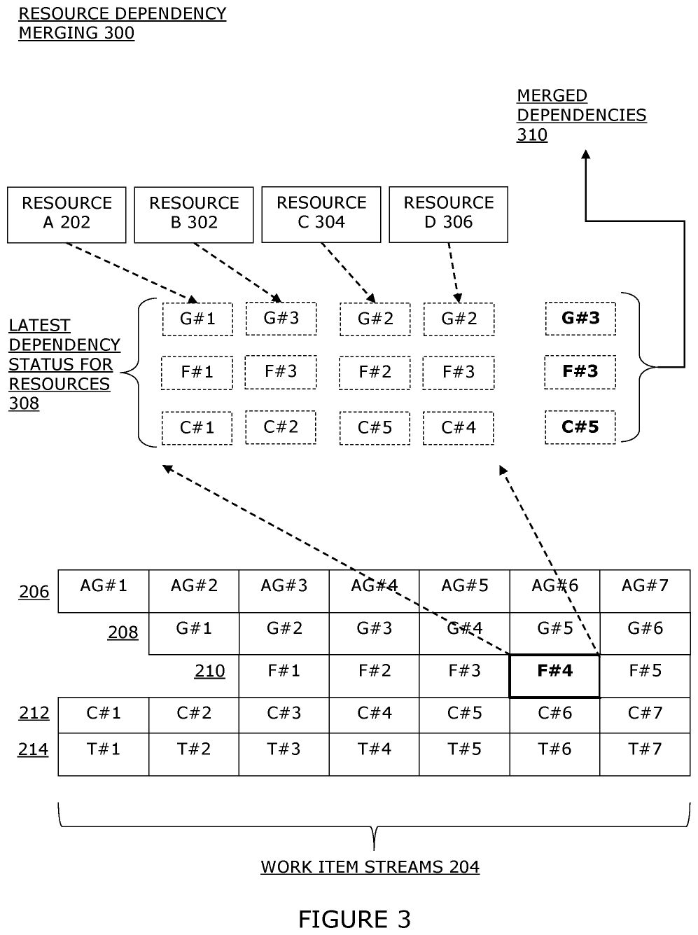

FIG. 3 shows a simple example of the merging of resource dependencies according to an implementation of the present technology;

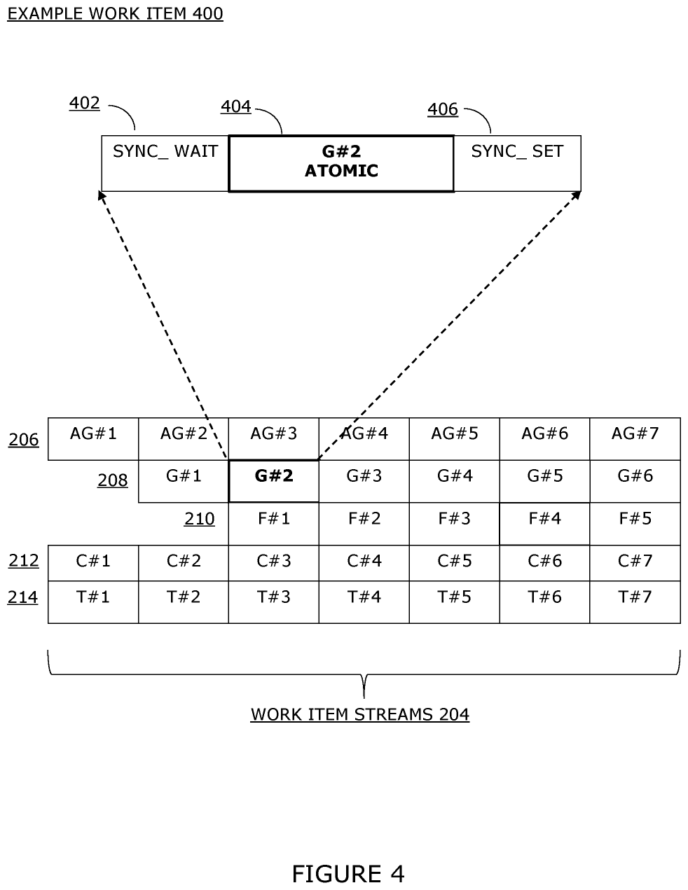

FIG. 4 shows a simple example of a resulting atomic work item according to an implementation of the present technology; and

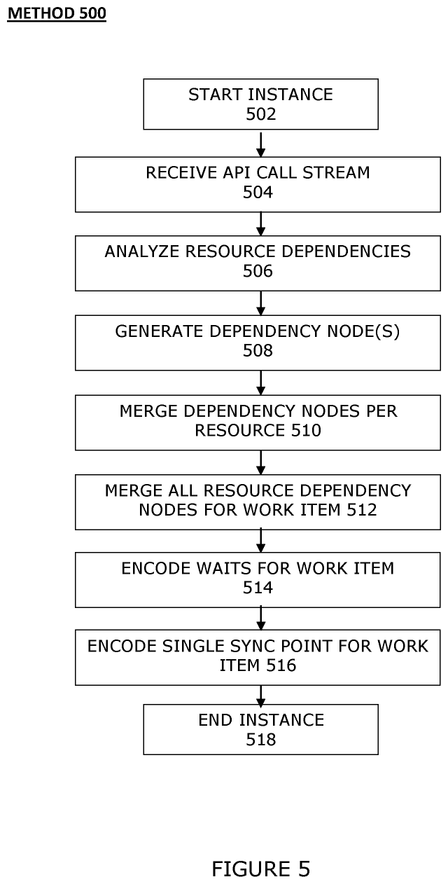

FIG. 5 shows a simplified view of a method of operation according to an implementation of the present technology.

In modern computing, data processing of various kinds is accomplished using parallel processing, in which work items are provided to multiple execution units (such as processor cores) for execution. Some of this data processing is performed by supplying command streams to the execution units, where the command streams comprise instructions for performing operations on data (such as arithmetic operations, data transformation operations and the like) and instructions for controlling the flow of execution (such as conditional branches and the like).

In parallel processing systems that use the command stream structure, the command streams need to be built by some form of pre-processor before they are passed to the execution units. The pre-processor typically takes as input the instructions from a program and converts them into suitable sequences of commands for execution in parallel by the various execution units. In so doing, the pre-processor needs to take into account the resolution of any dependencies that are contained in the sequences of commands. For example, within a sequence of instructions to be performed by a single execution unit, one instruction may require that another instruction be performed first. This is easily addressed by imposing a strict ordering of the instructions supplied to the single execution unit. However, other dependencies are not so easily addressed. For example, an instruction to be performed on one execution unit may require that another instruction be performed first on a different execution unit or that some data to be consumed by one execution unit has first been transformed by a different execution unit.

This requires a degree of synchronization between the command streams to be executed in parallel on the various execution units, and this is typically accomplished by inserting explicit synchronization commands into the command streams on the queues for the execution units, so that, for example, the first stream is instructed to wait for a completion event to be received from another execution unit. In any real-world application, these data dependencies and cross-queue dependencies may be very many and very complex in their interactions, and may lead to an unacceptable amount of processing time and energy being consumed merely in order to maintain correct synchronization.

In a concrete example in the field of graphics processing units, shader execution units may operate in parallel to process streams of draw call commands which require access to graphical data resources that may be shared. In such cases, in order to achieve proper processing outcomes that respect all the dependencies, a typical system will generate a plurality of cross queue synchronization points-“per-draw, per-resource, per-access” tracking. This is typically costly in time and processor and memory overhead, and in complex cases may be significantly so.

There is thus provided in the present technology an apparatus, method and non-transitory storage medium storing a computer program for significantly reducing the number of synchronizations required for command stream processing.

The command stream timeline of the present technology is based on a command stream execution order that is equivalent to the submission order, guaranteed by timeline CQS (cross queue synchronization) which may be implemented as a sequential increasing synchronization primitive. During command stream building and submission, the timeline CQS is inserted in the command streams in order in a cumulative manner. Based on this inherent ordering of the timeline, any command wait that is set for a larger value timeline CQS can cause the system to ignore any smaller value timeline CQS in the same command stream. This means that all the synchronizations having smaller timeline CQS values than the latest timeline CQS value can be eliminated.

The timeline based synchronization reduction method comprises two parts:
Reduction in the number of synchronizations required for resource access dependencies; and
Reduction in the number of stream execution synchronizations required for work item dependencies.

These parts may be implemented in a pre-processor arrangement in hardware, firmware, software, or any hybrid combination of these, operable to analyze the dependencies and to reduce their number when constructing the wait and synchronize structures for a command stream to be executed by one or more execution units.

The present technology may be implemented in any form of parallel processor environment and may comprise structures involving client-server or main host and accelerator arrangements wherein a first computing entity calls upon the services of another for the fulfilment of its processing requirements.

In one implementation, the present technology may be embedded in an electronic device, for example, a portable device, such as a mobile phone, tablet, or the like. The data processing system comprises a host processor (embodied as a central processing unit: a CPU). The host processor executes an operating system, such as Android. Various applications, such as games, may be executed using the operating system. In alternatives, the present technology may be implemented in computer systems such as servers, laptop or desktop computers, running other operating systems well known to those of ordinary skill in the art. In a further alternative, the technology may be implemented in systems comprised in cloud or grid arrangements, in which virtualised machines may operate to perform non-native processing instructions on a variety of otherwise incompatible machine architectures.

The data processing system of this implementation may further comprise an accelerator that is operable to process data under the control of the operating system on the host processor. For instance, applications running on the operating system of the host processor may require additional processing resource. The host processor may thus make calls to the accelerator for performing processing work, and the calls may then be built into a command stream suitable for execution by the accelerator's processing cores or execution units.

The accelerator may be any suitable accelerator that can, e.g., provide a processing resource for the host processor. The accelerator could, for example, comprise a graphics processing unit (GPU) or video processor (VPU), an encryption accelerator, a video accelerator, a network (processing) interface, a digital signal processor (DSP), audio hardware, etc. The accelerator can essentially comprise any component (execution/functional unit) that is optimised for a particular task. The processing that is to be performed by the accelerator can thus be any suitable and desired processing that the accelerator can perform. This will typically depend on the nature of the accelerator. For example, in an implementation, the accelerator comprises a GPU. In that case, the processing to be performed may comprise appropriate graphics processing, such as effects processing, overlay generation, display frame composition, etc.

Turning to FIG. 1, there is shown a simplified example of a system 100 in which an implementation of the present technology may operate and comprising any combination of hardware, firmware, software and hybrid components. System 100 comprises a processor 102, which may be embodied in the form of one or more computing entities, such as microprocessors. Processor 102 is operable to receive requests, calls or instructions from application 104. Processor 102 is operable in electronic communication with memory 112, which may be embodied in any form of electronic or electromagnetic storage media, whether now known or not. Memory 112 may, for example, be in the form of random access memory, or the like. Processor 102 is responsive to the requests, calls or instructions from application 104 to pass the requests, calls or instructions to driver 106. Driver 106 comprises command stream builder 108, which is operable to construct command streams in one or more instances of command queue 110 and place them in memory 112 in a suitable form for execution by one or more instances of execution unit 118 in GPU 114, under the instruction of command stream executor 116. GPU 114 is used here as an example of an accelerator that may be used to implement the present technology. Command stream builder 108 has been shown here as a singular example, but in a real-world application, there may be many instances of command stream builder 108. In a typical configuration according to the present technology, the requests to build the queues may come from application(s) running on a host which incorporates a pre-processor (via an API such as GLES) to a driver which is building the command queues and then informs the GPU (accelerator) 114 that new work is available (e.g. by writing to a control register in the accelerator to “kick” it). The command stream executor 116 in the GPU (accelerator) 114 would then see these new queue(s) and execute them on its execution units.

Although not shown in the figure, there may be many instances of command queue 110 and execution unit 118.

In an implementation relating to the field of computer graphics, the present technology can provide a GPU command stream timeline based synchronization reduction method in computer graphics. This method is suitable for high performance and low power graphics rendering in high efficiency GPU command stream generation. It can achieve a number of improvements including: optimal GPU rendering performance, minimizing GPU rendering synchronization and latency, reducing GPU memory bandwidth, improving GPU power saving, and the like. The use cases for such an implementation include: GPU 3D graphics rendering, 3D gaming, AR/VR, 2D graphics (GUI and 2D gaming etc. However, the improvements may also be seen by one of skill in the art to any form of parallel processing using at least some shared resource, such as the processing of tensor data in artificial intelligence applications.

Turning now to FIG. 2, there is shown a simple example of the analysis of resource dependencies according to an implementation of the present technology. The example shown in FIG. 2 demonstrates the first part of the timeline based synchronization reduction method according to the present technology—the reduction in the number of synchronizations required for resource access dependencies. The example shown in FIGS. 2, 3 and 4 is directed to an implementation in a GPU setting wherein the processing comprises processing of, among other things, geometrical data. As will be clear to one of ordinary skill in the art, the present technology is not limited to such implementations, and as indicated above, may be applied in many other use cases requiring synchronization during parallel processing.

FIG. 2 is arranged in the form of a resource dependency timeline 200 from left to right, in which a resource A 202 is available for access by work item streams 204 of the type found in a typical parallel processing GPU. The work item streams 204 are arranged as queues, and as described above, there may be data and other processing dependencies between different queues. These may be different queues on the same data processor (e.g., a geometry processing queue and a fragment processing queue on a graphics processor), or may be different queues on a different processor (e.g., the CPU, a display controller, a video decoder, etc.). For example, in the context of graphics processing, the graphics processor may execute parallel geometry processing and fragment processing queues with the fragment processing queue waiting on input data from the geometry processing operations. In that case, the geometry processing queue may perform various operations to generate the required geometry data for input to the fragment processing queue so that the fragment processing queue has a data (and order) dependency on the geometry processing queue.

A synchronisation mechanism is thus needed between the different processing queues. For example, the fragment processing queue may need to be instructed to wait until the geometry processing queue has completed a set of required operations, at which point the geometry processing queue may implement a suitable (synchronisation) operation to inform the fragment processing queue that the geometry data is available, and to cause the fragment processing queue to start processing this data.

Work item streams 204 comprise, in this example, advanced geometry stream 206, geometry stream 208, fragment stream 210, compute stream 212 and transfer stream 214. Each stream comprises work items of that particular type, for example, advanced geometry work item AG #1, fragment work item F #4, and so on. As will be clear to one of ordinary skill in the art, the work item streams of this example do not form an exhaustive list of work item streams, but are merely a convenient selection of work item streams relating to graphics processing. Many other types of work item stream may be envisaged by one of skill in the art—for example, there may be a work item stream defined as the “neural” stream, for processing machine learning/artificial intelligence work streams using, for example, artificial neural network technology.

Each work item is given a sequence number according to its execution order—each sequence number corresponds to the envisioned completion of an item of work within that queue and thus could mark a point of dependency for further work items (in the same or other queues-thus, each sequence number may represent a potential cross queue synchronization requirement.

To clarify, in this discussion, the terms “potential” and “actual” do not refer to execution time facts or states, but to the situations exposed by analysis of the command streams relative to the timeline during the build process prior to any command stream execution.

Shown in the figure are the examples of actual read/write dependencies 216, where, for example, G #1, F #1, C#4, F #3, C#6 and F #4 each have a dependency upon resource A 202. By analysing the dependencies 216 according to their relative positions on the timeline, the present technology determines that the latest in sequence of these actual dependencies for resource A 202 are geometry work item G #1, fragment work item F #4 and compute work item C#6. According to the present technology, any earlier actual dependencies may be eliminated from consideration as requiring synchronization, because that need is subsumed into the latest actual resource A dependency synchronization requirement and thus the number of synchronizations for the resultant command stream can be reduced.

In one example implementation, the above can be achieved during the command stream build process by creating a dependency node “owned” by resource A 202 and in which the latest actual state of the dependencies is maintained, so that any earlier actual dependencies will be implicitly fulfilled when the latest actual dependency synchronization is performed. In the example, the resource A dependency node may be represented as follows:

```
struct dependencyA
{
  u64 adv_geometry;
  u64 geometry;
  u64 fragment;
  u64 compute;
  u64 transfer;
  void* external
}
```

where each work item stream has an unsigned integer value to be maintained as the sequence number of the latest actual resource A dependency for that work item stream. As will be immediately clear to one of skill in the art, this structure is merely one example of the types of work item stream that may need to be accommodated. In the case referred to above wherein a work item stream is required for processing machine learning/artificial intelligence work streams using, for example, artificial neural network technology, it may be defined as u64 neural within a struct definition similar to that shown above.

Turning now to FIG. 3, there is shown a simple example of resource dependency merging 300 according to an implementation of the present technology. Whereas FIG. 2 concerned itself with the first part of the timeline based synchronization reduction method according to the present technology—the reduction in the number of synchronizations required for resource access dependencies-FIG. 3 concerns itself with the second part of the timeline based synchronization reduction method according to the present technology—the reduction in the number of stream execution synchronizations required for work item resource dependencies.

Shown in FIG. 3 are the work item streams 204 (comprising advanced geometry stream 206, geometry stream 208, fragment stream 210, compute stream 212 and transfer stream 214) as described in the description of FIG. 2 above. The work item of interest is marked in bold-F #4, a work item in fragment work item stream 210, which is being built in the command stream pre-processing stage.

During the process of building the command stream work item F #4, the analysis shows that fragment work item F #4 needs to access five resources (resource A 202, resource B 302, resource C 304 and resource D 306). Each resource has a unique dependency node generated according to the implementation of the present technology described in relation to FIG. 2 above—the timeline approach to per-resource dependency analysis and reduction. Thus resource A has latest actual dependencies G #1, F #1 and C#1, derived using the analysis described above with reference to FIG. 2. Resource B has latest actual dependencies G #3, F #3 and C#2, similarly derived. Resource C has latest actual dependencies G #2, F #2 and C#5, and Resource D has latest actual dependencies G #2, F #3 and C#4. These dependencies are shown in FIG. 3 at latest dependency status for resources 308.

Thus, as shown in FIG. 3, fragment work item F #4 will, on execution, access resources A, B, C and D, the dependencies for which are shown in latest dependency status for resources 308. The dependency node for resource A 202, for example, shows the latest actual dependencies G #1, F #1 and C#1, which means that resource A will be made available after work G #1, F #1 and C#1 are completed. The same applies to the other three resources shown in the example.

Using a similar timeline based approach to that taken to derive the latest actual dependencies, it is possible to reduce the number of synchronizations further by merging these per-resource dependency nodes to give merged dependencies 310—G #3, F #3 and C#5. In this manner, the final merged work item dependency node 310 can indicate all the timeline resource dependencies for fragment work item F #4, which can then be applied in the work item F #4 command stream encoding.

Using the described timeline approach to resource dependency and work item dependency synchronization reduction, it is possible for the pre-processor of the present technology to set up the preconditions for fragment work item F #4 to start execution.

This can be achieved by, for example, encoding the following for a first command stream/queue:

Wait Timeline_CQS_G <3>
Wait Timeline_CQS_F <3>
Wait Timeline_CQS_C <5>
CALL linear command buffer of fragment work item F#4
Signal Timeline_CQS_F <4>

The last Signal will notify any other work items which are waiting on Wait Timeline_CQS_F<4>.

The relevant operations for the further command streams/queues will be signalled by:

...
CALL linear command buffer of geometry work item G#3
Signal Timeline_CQS_G <3>
...
CALL linear command buffer of fragment work item F#3
Signal Timeline_CQS_F <3>
...
CALL linear command buffer of compute work item C#3
Signal Timeline_CQS_C <5>

Where, as will be clear to one of skill in the art, each CALL and Signal operation belongs to a different queue.

In this manner, the present technology merges and encodes the synchronizations into the command stream based on the timeline approach shown in FIGS. 2 and 3.

In a further refinement, because the work item in question is fragment work item F #4, and because the timeline sequencing is strict, by implication the explicit Wait Timeline_CQS_F<3> is not needed, and can be eliminated from the encoding, thus:

Wait Timeline_CQS_G <3>
Wait Timeline_CQS_C <5>
CALL linear command buffer of fragment work item F#4
Signal Timeline_CQS_F <4>

In FIG. 4, there is shown a simple example of a resulting work item 400 according to an implementation of the present technology. FIG. 4 shows work item streams 204 (comprising advanced geometry stream 206, geometry stream 208, fragment stream 210, compute stream 212 and transfer stream 214), as shown in FIGS. 2 and 3 and described with reference thereto. In this example, the work item of interest is geometry work item G #2, shown in bold. The result of the analysis and reduction stages described hereinabove is shown in the expanded view of geometry work item G #2, which now comprises SYNC_WAIT 402, the commands for the now atomic geometry work item G #2 404, and SYNC_SET 406. Following the pre-processing stages, the work item in question (in this example case, geometry work item G #2 404) becomes an atomic unit of execution, preceded by the required one or a plurality of wait operations, and succeeded by a single synchronization signal set for the completion of the work item.

As will be clear to one of ordinary skill in the art, being aware of the synchronization requirements of parallel command stream processing, this represents a significant reduction in the processing overhead incurred by maintaining synchronization. In particular, one of ordinary skill in the art will be aware of the importance of such a reduction in resource constrained processing environments, such as portable and/or wearable devices and any devices constrained by communications bandwidths and/or intermittency of communications connection.

FIG. 5 shows a simplified view of a method of operation of a computing entity according to an implementation of the present technology. An instance of the method 500 of preparing a command stream for a parallel processor according to an implementation of the present technology begins at START INSTANCE 502. At 504, an application programming interface (API) call stream is received—the call stream may be received, for example, at an accelerator from an external entity, such as, for example, a CPU, or it may originate locally, whereby the API call stream is retrieved from a storage medium into the computing entity. It is envisioned, in an implementation, that the call stream is received into a pre-processor for a preparation/build stage before being submitted, for example via a queue, to one or more execution units of the computing entity.

At 506, the resource dependencies of the elements of the call stream are analyzed in terms of their relative sequencing over a timeline, where the resource dependencies in question may comprise dependencies on access to, or the state of contents of, data sources, such as external memory or internal cache, or they may comprise processing resources, such as required prior processing steps. At 508, a dependency node is generated for the or each dependency on the resource by a work item in a work item stream. At 510, the dependency nodes for each resource are merged to derive a single dependency node for the or each resource. At this point, the dependencies are reduced in number to only the latest actual dependencies (as described above for FIGS. 2 and 3) for the or each resource. At 512, the latest actual dependencies of the or each per-resource node are merged to define a latest dependency node for the command stream work item. As will be clear to one of skill in the art, the description here has been simplified to refer only to the constructs required for implementation of the present technology. In a real world implementation, there will be additional steps of building the command streams to achieve the actual task work, but these have not been shown, for simplicity of representation.

At 514, the reduced set of WAITs for the merged dependency nodes of the work item are encoded. At 516, a single synchronization point for the work item is encoded, and at 518, this instance of the method ends.

As will be clear to one of ordinary skill in the art, END INSTANCE 518 merely completes a single instance of method 500, and the method will typically be iterative, returning to START 502 for the next instance and further instances.

There is thus provided a technology for the control of parallel processing in electronic systems, such as electronic computing systems, and in particular to the control of synchronization in command stream based parallel processing.

In an implementation, the technology may comprise a method of preparing a command stream for a parallel processor, comprising: analysing the command stream to detect at least a first dependency; generating at least one timeline dependency point responsive to detecting the first dependency; determining a latest action for the first dependency to derive a completion stream timeline point for the first dependency; comparing the completion stream timeline point for the first dependency with a completion stream timeline point for a second dependency to determine a latest stream timeline point; generating at least one command stream synchronization control instruction according to the latest stream timeline point; and providing the command stream and the at least one command stream synchronization control instruction to an execution unit of the parallel processor.

In an implementation, the method of preparing the command stream can be carried out by a pre-processor function of a command stream builder. Analysing the command stream to detect at least a first dependency may comprise detecting a resource access dependency and/or detecting that the command stream comprises plural work item queues and detecting a cross-queue synchronization dependency.

Generating at least one command stream synchronization control instruction may comprise generating at least one wait instruction to cause a wait before execution of the command stream and/or generating at least one synchronise instruction to cause a synchronization after execution of the command stream.

The present technology may further be implemented in an apparatus for preparing a command stream for a parallel processor, comprising: electronic logic components for analysing the command stream to detect at least a first dependency; electronic logic components for generating at least one timeline dependency point responsive to detecting the first dependency; electronic logic components for determining a latest action for the first dependency to derive a completion stream timeline point for the first dependency; electronic logic components for comparing the completion stream timeline point for the first dependency with a completion stream timeline point for a second dependency to determine a latest stream timeline point; electronic logic components for generating at least one command stream synchronization control instruction according to the latest stream timeline point; and electronic logic components for providing the command stream and the at least one command stream synchronization control instruction to an execution unit of the parallel processor.

As will be appreciated by one skilled in the art, the present technology may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product tangibly embodied in a non-transitory computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

What is claimed is:

1. A computer-implemented method of preparing a command stream for a parallel processor, comprising:
analysing the command stream to detect at least a first dependency;
generating at least one timeline dependency point responsive to detecting the first dependency;
determining a latest action for the first dependency to derive a completion stream timeline point for the first dependency;
comparing the completion stream timeline point for the first dependency with a completion stream timeline point for a second dependency to determine a latest stream timeline point;
generating at least one command stream synchronization control instruction according to the latest stream timeline point; and
providing the command stream and the at least one command stream synchronization control instruction to an execution unit of the parallel processor.

2. The method according to claim 1, wherein the preparing the command stream comprises a pre-processor function of a command stream builder.

3. The method according to claim 1, wherein analysing the command stream to detect at least a first dependency comprises detecting a resource access dependency.

4. The method according to claim 1, wherein analysing the command stream to detect at least a first dependency comprises detecting that the command stream comprises plural work item queues.

5. The method according to claim 4, wherein analysing the command stream to detect at least a first dependency comprises detecting a cross-queue synchronization dependency.

6. The method according to claim 1, wherein generating at least one command stream synchronization control instruction comprises generating at least one wait instruction to cause a wait before execution of the command stream.

7. The method according to claim 1, wherein generating at least one command stream synchronization control instruction comprises generating at least one synchronise instruction to cause a synchronization after execution of the command stream.

8. An apparatus for preparing a command stream for a parallel processor, comprising:
a memory;
a processor having logic circuits comprising:
a dependency detector operable to analyse the command stream to detect at least a first dependency;
a stream timeline point generator operable to generate at least one timeline dependency point responsive to detecting the first dependency;
a timeline dependency point analyser operable to determine a latest action for the first dependency to derive a completion stream timeline point for the first dependency;
a comparator operable to compare the completion stream timeline point for the first dependency with a completion stream timeline point for a second dependency to determine a latest stream timeline point;
a command stream synchronization control instruction generator operable to generate at least one command stream synchronization control instruction according to the latest stream timeline point; and
an output generator operable to provide the command stream and the at least one command stream synchronization control instruction to an execution unit of the parallel processor.

9. The apparatus according to claim 8, wherein apparatus for preparing the command stream comprises a pre-processor of a command stream builder.

10. The apparatus according to claim 8, wherein the dependency detector is operable to detect a resource access dependency.

11. The apparatus according to claim 8, wherein the dependency detector is operable to detect that the command stream comprises plural work item queues.

12. The apparatus according to claim 11, wherein the dependency detector is operable to detect a cross-queue synchronization dependency.

13. The apparatus according to claim 8, wherein the command stream synchronization control instruction generator is operable to generate at least one wait instruction to cause a wait before execution of the command stream.

14. The apparatus according to claim 8, wherein the command stream synchronization control instruction generator is operable to generate at least one synchronise instruction to cause a synchronization after execution of the command stream.

15. A non-transitory storage medium storing program code to prepare a command stream for a parallel processor, by:
analysing the command stream to detect at least a first dependency;
generating at least one timeline dependency point responsive to detecting the first dependency;
determining a latest action for the first dependency to derive a completion stream timeline point for the first dependency;
comparing the completion stream timeline point for the first dependency with a completion stream timeline point for a second dependency to determine a latest stream timeline point;
generating at least one command stream synchronization control instruction according to the latest stream timeline point; and
providing the command stream and the at least one command stream synchronization control instruction to an execution unit of the parallel processor.
